(19) United States
(12) Patent Application Publication
(10) Pub. No.: US 2015/0182961 A1
(43) Pub. Date: Jul. 2, 2015

(54) Laboratory Device System and Laboratory Device for Treating Fluids and Solids, and Method for Operating a Laboratory Device

(71) Applicant: Eppendorf AG, Hamburg (DE)

(72) Inventors: Matthias Arnold, Aachen (DE); Guido Ertel, Dormagen (DE); Lars Borrmann, Bremen (DE); Jan-Gerd Frerichs, Norderstedt (DE)

(21) Appl. No.: 14/389,383

(22) PCT Filed: Apr. 3, 2013
(86) PCT No.: PCT/EP2013/057006

§ 371 Date: Mar. 13, 2015

Related U.S. Application Data
(60) Provisional application No. 61/619,629, filed on Apr. 3, 2012.

(30) Foreign Application Priority Data
Apr. 3, 2012 (DE) 10 2012 102 918.0

(51) Int. Cl. B01L 3/02; G01N 35/00; H04L 29/08

(52) U.S. Cl. CPC B01L 3/0237; H04L 67/10; G01N 35/00871; B01L 2300/023; G01N 2035/00881; G01N 2035/00891

(57) ABSTRACT

The invention relates to a laboratory device system and a laboratory device (1.6) for treating fluids and solids, comprising a device module (7) with a unit (2) for treating fluids and solids and an operating and/or display unit (3), an operating and/or display module (8) physically separated from the device module (7) and encompassing the operating and/or display unit (3) in whole or in part, and means (10, 11) for wireless communication (9) between the device module (7) and the operating and/or display module (8), wherein the laboratory device system has an information management system (40), which is arranged remotely from the laboratory device (1.6), is connected to the operating and/or display module (8) via at least one communication channel (CH) and exchanges data with the operating and/or display module (8) when the laboratory device (1.6) is operated.

The invention relates to a laboratory device system and a laboratory device treating fluids and solids. In addition, the invention relates to a method for operating such a laboratory device.

In particular the invention relates to laboratory device systems where laboratory devices such as, for example, a pipette, photometer, centrifuge, mixer, thermo-mixer, shaker, thermo-cycler, real-time cycler, DNA sequencer, gel-based equivalent, device for arrays, laboratory machine (workstations), dosing station, bio-reactor, control for bio-reactors and other laboratory devices for the treatment of fluids and solids are used. As an example of this, a pipette will be described.

Laboratory devices for the treatment of fluids and solids comprise operating and display units to set, program, start, control, stop and monitor the features thereof. Generally, as laboratory devices are becoming more and more complex, operating and display units with more complex input devices and larger displays are used. This requires more space, increases weight and makes the laboratory devices significantly more expensive. If the laboratory device comprises only a small operating and display unit, ease-of-use will be compromised. This will be described below by using pipettes as an example, whereas the invention is applicable to any type of laboratory device:

Pipettes are handheld or stationary dosing devices, which are particularly used in laboratories for the dosing of fluids. Special versions of pipettes include, for example, air displacement pipettes and direct displacement pipettes which may be configured as dispensers. In addition, there are single channel pipettes used with single and multi-channel pipettes for simultaneous use with a plurality of pipetting tips or syringes.

Many of those laboratory devices known generally comprise operating elements. Thus, pipettes comprise, for example, operating elements for controlling the intake and dispensing of fluids and, optionally, for detaching the pipette tip or syringe from the pipette. In addition, they comprise operating elements which may be used for the manual inputting of application parameters (e.g., dosing volume, dosing speed, physical characteristics, calibration data) and/or of types of operation (e.g., pipetting, dispensing, titrating, mixing) and/or of workflows for sample processing (e.g., intake, mixing and dispensing of fluids). In addition, a display unit is provided to display operating data (e.g., user data, kind of operation, workflows, operation state) of the pipette.

The operating and display units are mainly located at the upper end of the pipette (i.e., the laboratory device). At this point, the pipette housing is generally enlarged to accommodate these elements. Pipettes with a largely rod-shaped housing, where the upper end thereof comprises a flat inclined housing head which may be protruding to one side, are well-known. In this housing head, electric switches or keys and at least one display are accommodated. Displays of the liquid crystal kind (LCD displays) are used. Said pipettes are described in EP 1 825 915 A2, EP 1 859 869 A1, and EP 1 878 500 A1.

Taking pipettes as an example, it may be conceived that known configurations of laboratory devices have shortcomings: One disadvantage of pipettes is that due to the contained operating and display units, they protrude to the upper side, are heavy and hard to operate and to read despite their small size. Thus, the handling of the pipettes is compromised and comes with the risk of a possible operating error. In addition, the operating and display units account for a significant part of the cost of the pipette. More complex tasks like creating routines or programs are hard to accomplish with integrated operating and display units. Where pipettes are equipped with small operating and display units, this further deteriorates their ease of use.

DE 199 11 397 A1 describes a laboratory device configured as a kind of autonomous pipette comprising a device control and sensor apparatus for detecting operating data, which comprises a wireless interface for data transfer and/or device control. By using a remote control, the pipette may be controlled more comfortably via an interface. Without a remote control, the autonomous pipette may be used in a conventional way. The autonomous pipette therefore requires operating and display units.

EP 0 999 432 A1 describes a laboratory device system configured as an electronic dosing system, wherein routines for performing workflows in a manual dosing apparatus are inputted using a data processing system via wired or wireless data interfaces. In addition, operating parameters may be inputted into the manual dosing apparatus and the manual dosing apparatus may be controlled using the data processing system. The operating parameters are user parameters (e.g., dosing volume, dosing speed), device type-specific parameters (e.g., piston movements, parameters defining quantities, parameters for monitoring operating states) or device-specific parameters (e.g., device identification, ID code for stored parameter set). The manual dosing apparatus comprises separate operating and display units.

A similar laboratory device system configured as a dosing system is described in WO 2005/052781 A2. The pipette is also provided with separate operating and display units.

U.S. Pat. No. 7,640,787 B2 describes an inspection apparatus for a pipette. The pipette comprises means for measuring the volume displaced by the piston of a pipette, comparing the measurement with the desired value and displaying an error. The error message will be displayed by an LCD display on the pipette. In addition the result of the comparison may be transmitted wirelessly to a computer using an interface. The pipette contains separate operating units and a separate counter to display the fluid volume to be dispensed.

U.S. Pat. No. 4,821,586 describes the laboratory device system configured as a pipette system, where a pipette (actual laboratory device) is controlled by a programmable control unit to perform a dosing function selectable from a pool. This may be, for example, the pipetting of single fluid volumes, the dispensing of some partial volumes of an intaken fluid volume, dilutions or titrations. The control unit also supports the writing and storing of new programs for dispensing features. The control unit contains the control of the pipette and is connected to the motor, switches and small lights of the pipette via a flexible electric cable.

WO 89/10193 describes a pipetting apparatus comprising a stationary unit with a piston pump, a step motor to drive a piston pump and a microprocessor to control the step motor. By using an input box connected to a microprocessor via electrical cables, data and programs may be inputted into the microprocessor. The input box comprises a display, which requires control commands, returns responses and displays the state of the apparatus. A pipette handle comprises electronic operating elements to trigger several features including aspiration, dispensing and mixing features. The electronic operating elements are connected to the microprocessor via a second electric cable and the pipette handle is connected to the piston pump using a pneumatic hose. A pipette tip may be connected to a connector of the pipette handle. Thus, the stationary unit comprising the piston pump and the microprocessor, the input box and the handle are separate device components connected to each other via a flexible cable.

DE 195 06 129 A1 describes a toothbrush comprising a pressure sensor in its handle to detect the correct pressure to be applied during teeth cleaning. The detected pressure values are forwarded by a transmitter and transmitting antenna at the handle to an external display unit comprising a receiving antenna. It displays whether the teeth are being cleaned with adequate pressing force. In addition, it is configured to detect the cleaning period for different areas of the teeth and to signal this.

WO 2008/131874 A1 describes a method for wireless undirectional transmission of data between a sender and a receiver, wherein the sender sends a data set to be transmitted consecutively on a plurality of transmission channels and the receiver receives data sets on only one transmission channel. The number of transmission channels used is smaller than the number of repetitions the transmitter uses to transmit the data set, and a sequence of transmission channels is used where the order of the transmission channels used has been defined in advance. In addition, it describes a toothbrush comprising a transmitter to execute the method described above and a system consisting of a toothbrush and separate additional device, where the toothbrush comprising a transmitter and the additional device contains a receiver. The additional device is equipped with a display device to display the data transmitted. For example, the contact pressure of the toothbrush is determined by which the user presses the brush head against his teeth while cleaning the teeth and/or the cleaning period and/or the charging status of a rechargable battery inside the handle for the power supply of the electric toothbrush.

WO 98/257 36 A1 describes an electric shaving system comprising an electric shaver and a remote control unit with a display unit to display specific data. The display unit displays status messages related to the shaver and provides the user with feedback during shaving. Furthermore, the remote control unit may be equipped with buttons, sensing devices or sliders to adjust the shaving parameters of the shaver. In addition, the remote control unit may comprise sensors for environmental conditions to provide the shaver with significant information related to shaving comfort. Data exchange between the remote control unit and the shaver may be wireless and bidirectional, if required.

Further prior art is described in EP 2 416 267 A1, WO 2009/066 179 A1 and WO 2010/086 862 A1. In addition, the non-published but former German patent application number 10 2010 047 828.8 is to be mentioned.

Based on these and in particular on the known laboratory device system of DE 199 11 397 A1, it is an object of the invention to provide a laboratory device system and a suitable laboratory device where the features and handling has been improved and/or enhanced.

This problem is solved by a laboratory device system according to the features of claim 1. Advantageous embodiments of the laboratory device system are specified in the dependent claims.

The laboratory device system according to the invention comprises a laboratory device for the treatment of fluids and solids comprising the following components or modules:
at least one device module for use in a laboratory for a treatment of fluids and solids,
at least one operating and/or display unit for a treatment of fluids and solids,
at least one operating and/or display unit physically separated from the device module, which comprises the operating and/or display unit in whole or in part, and
first means for wireless communication between the device module and the operating and/or display module,
   wherein the laboratory device system comprises a higher-level information management system at a remote location and is connected to the operating and/or display unit via at least one communication channel, which is capable of exchanging data between the operating and/or display module or directly with said device module.

Laboratory devices according to the present patent application are devices for treating fluids (fluids or gases) and solids by impacting them in order to achieve a predetermined objective without modifying the fluids and/or by modifying the fluids. The impact may comprise the intake and/or outlet and/or dosing and/or pipetting and/or dispensing and/or titrating and/or mixing and/or transporting and/or keeping and/or storing and/or tempering and/or analysing and/or modifying of the physical and/or chemical and/or biochemical properties of fluids. Fluids refer to fluid media in the form of samples, which are single phase fluids or fluid mixtures or multi-phase fluid mixtures (e.g., emulsions) or a mixture of fluids and solids (e.g., suspensions) or mixtures of fluids and gases (e.g., foams). Laboratory devices according to the present invention may relate to any kind of devices being configured for the treatment of fluids in a laboratory such as, for example, photometers, centrifuges, mixers, thermo-mixers, shakers, thermo-cyclers, real-time cyclers, DNA sequencers, gel-based equivalents, devices for arrays, laboratory machines (workstations), dosing stations, bio-reactors (multi-use or single use) or bio-reactor controls.

Conventionally, parts of laboratory devices for the treatment of fluids and solids are combined in a physical unit. Here, the operating and display elements are integrated into the unit for a treatment of fluids in one common housing. In one embodiment, the laboratory device is divided into physically separated parts, namely a device module and a physically separate operating and/or display module. The device module comprises the means for the treatment of fluids and solids. The means for the treatment of fluids and solids is the part of the laboratory device that impacts the fluids to achieve a predetermined objective without modifying the fluids and/or in order to modify the fluids. The operating and/or display module comprises the operating and/or display unit in whole or in part. Furthermore, the laboratory device according to the invention comprises means for wireless communication between the device module and the operating and/or display module. These are configured to transmit data from the device module to the operating and/or display module and/or in the opposite direction. The device module and the operating and/or display module communicate with each other via the means for wireless communication (preferably within a near-field area smaller than 5 cm) to perform the data exchange required for operation and/or display. Communication between the modules may be unidirectional or bidirectional.

In addition, the laboratory device system comprises an information management system which is separate from the laboratory device and which is directly connected to the operating and/or display module or the device module via at least one communication channel (preferably over a larger distance than the near-field area or established by using a remote communication connection) in order to exchange data with the operating and/or display module during operation of the laboratory device. Bluetooth, WLAN and/or UMTS connections, for example, may be established for this purpose. IP data connections (intranet/Internet) may also be used. The information management system is preferably installed at a centralised location (company headquarters, maintenance centre, client centre etc.), and in one embodiment that has access to the Internet (World Wide Web). Based on this device architecture and network structure, a laboratory device system is created which is very easy to use in terms of the handling of the laboratory device, and is capable of providing and supporting a plurality of operating and maintenance features in a centralised way. In addition, the parts and features of the operating and/or display module (smartphone; tablet PC) may cooperate with the information management system to perform a plurality of new, easy-to-use features.

The information management system described in detail later delivers a plurality of outputs and may be considered as a system to aggregate, accumulate, manipulate, analyse, combine and perform a synthesis of data from an environment consisting of at least one laboratory device system. The data generated from the system may be used to control processes, gain knowledge, create profiles, create user groups and manage access, control access to systems, devices and device modules, perform maintenance, locate devices and persons, create a database, document experiments, track samples, automatically generate offers, carry out an inventory, for exchange in expert/user forums and to prepare experiments (keyword DoE). Basically, any usage/processing forms are conceivable for the information that result from the usage of the electronic data processing system.

In addition, the information management system may comprise access to the Internet/intranet for example in order to network global operating companies, and to integrate third-party information into the data processing (e.g., link to a article to be purchased from a third-party provider).

The implementation of the information management may be achieved in a variety of ways. Laboratory device systems are conceivable in which the complete information management system is implemented on a stand-alone PC. In another embodiment, the company may have a centralised server which is also accessed by clients, which are “in charge of” a predetermined laboratory device system. In another embodiment, a server may be installed in any Cloud which may or may not be on the premise of the company operating the laboratory device system(s). In this case, the client computers would act as a gateway to the Cloud.

In order to realise this flexible implementation, the information management system may be designed in a modular way. Thus, in one embodiment, different and/or identical program parts of the information management system are implemented at different locations and/or on different computers which are networked via any network.

Integrated software components of the information management system are interfaces to the laboratory device system with its respective devices, interfaces to the information management system, interfaces to the user of the system, interfaces to other users, interfaces to the Internet/intranet and interfaces to third-party systems which eventually have to be coupled. Furthermore, such a system comprises one or more databases or access to one or more databases. Data from databases and online data will be processed by a respective main program which may also be implemented in a modular way (see above). This is based on respective information models.

The laboratory system according to the invention is preferably adapted as defined in the dependent claims:

Preferably, the operating and/or display module of the laboratory device and/or the device module comprise second means for a wireless and/or wired communication between the operating and/or display module or the device module and the information management system.

Preferably, the information management system comprises third means for a wireless or wired communication between the operating and/or display module or the device module and the information management system. The third means may be adapted for IP communication over a network, in particular, an intranet and/or the Internet.

Preferably, the device module is a handheld device and/or the operating and/or display module is configured to be portable by a person or is a handheld device. For example, the operating and/or display module is configured as a mobile telephone and/or personal digital assistant and/or smartphone and/or tablet PC.

The operating and/or device module can comprise at least one of a camera and/or barcode reader to perform an identification of samples and/or consumables using the information management system. Alternatively or in addition, the operating and/or device module may comprise at least one locating device, in particular a GPS module, to perform a geo-locating of laboratory devices, samples, consumables and/or users by the information management system.

The information management system and at least one database are adapted to create and manage a user account for the one or more users of the at least one laboratory device, respectively. For example, the information management system is capable of creating and managing an information forum/repository by using the at least one database for at least one group of users and/or laboratory devices.

For the laboratory device system, a plurality of device modules and/or operating and/or display modules may be provided which communicate with each other via point-to-point connections and/or point-to-multipoint connections. In addition, a plurality of particularly physically separated operating and/or display units may exist which communicate with each other via point-to-point connections and/or point-to-multipoint connections. The plurality of device modules and/or plurality of operating and/or display modules communicate with the plurality of operating and/or display units via point-to-point connections and/or point-to-multipoint connections.

The information management system comprises at least one computing unit connected to at least one database, in particular, a database configured as a Cloud system.

The first means for wireless communication between the device module and the operating and/or display module may be configured to communicate with each other only within a defined spatial area, in particular, within a near-field area. However, the second means for wireless or wired communication between the operating and/or display module or the device module and the information management system may be configured to communicate with each other over a defined spatial distance, in particular, a distance exceeding the near-field distance or via a remote communication connection, respectively.

The device module may comprise an electronic control unit to detect operating data and/or to control the unit for the treatment of fluids and solids.

Preferably, the operating and/or display module is configured such that operating parameters and/or operation types of the device module and/or control programs for the device module and/or routines for carrying out workflows of the device module may be entered or retrieved using an operating unit thereof. Furthermore, the operating and/or display module may be configured to be used for the remote control of device modules.

Preferably, in the case of communication with one of a plurality of device modules, the operating and/or display module is adapted to identify the respective device module, and to automatically set a device-specific user interface on the operating and/or display unit. In addition the operating and/or display module may also be adapted to permit usage only after entering proof of authentication. Furthermore, the operating and/or display module may be configured to allow the modification of predetermined programs, routines, measurement results and other data only after entering proof of authentication. In addition, the operating and/or display module may be configured to comprise a reservation feature which allows the laboratory device to be locked for predetermined periods of time for predetermined users.

The laboratory device system according to the present invention may be connected to an electronic data processing system physically separated from the device module and the operating and/or display module, where the information management system is implemented. The operating and/or display module may be connected to the device module in a detachable way.

A laboratory device system may be a mechanical, electronic or semi-electronic pipette, or a photometer, centrifuge, mixer, thermo cycler, real-time cycler, DNA sequencer, laboratory machine, dosing station, bioreactor or bioreactor system.

The invention also comprises a method for operating a laboratory device comprising a unit for the treatment of fluids and solids and at least one operating and/or display unit, wherein:
at least one device module comprising the unit for the treatment of fluids and solids is operated physically separate from the at least one display module comprising the operating and/or display unit, and
information, control data and/or data to be displayed is transmitted wirelessly between the device module and the operating and/or display module; and
data are exchanged via at least one communication channel with an information management system (40) which is remote to the laboratory device.

Preferably, the method is adapted such that a plurality of device modules exchange data with at least one operating and/or display module or such that at least one device module exchanges data with a plurality of operating and/or display modules. According to the method, the device module is used for pipetting and/or photometrically analysing and/or centrifuging and/or adjusting the temperature and/or mixing and/or cultivating and/or fermenting and/or performing a PCR.

Furthermore, the invention comprises a usage of a laboratory device system which is adapted to detect and document:

(a) usage data (e.g., user identity; device usage period; type of device usage (e.g., which rotor for centrifuges; gas supplies for an incubator and/or programs selected/entered for a bioreactor; workflow failures)); and/or
(b) data of the treated fluid and or solid sample (e.g., type of sample; characteristics of sample; sample names) and/or
(c) data about the consumables (type of container used); and/or
(d) measurement data (e.g., pH value, temperature; cell density; flows), in case the laboratory device actively performs measurements; and/or
(e) application data of applications (geo-localisation, data for techno-social networks, etc.)

The detected and documented data will be provided for a access by other users.

Compared to conventional laboratory devices, the device module comprises none or only a reduced operating and/or display unit. In particular, the device module may be configured without any operating and display unit, or without operating unit or display unit, or to contain only parts of the units. The operating and/or display unit is completely or partly outsourced in an operating and/or display module physically separate from the operating and/or display module. The operating and/or display module may provide any operating and/or display features of a conventional laboratory device. In case the device module comprises only a reduced operating and/or display feature, it is not able to carry out basic features of the laboratory device and/or to display the relevant operating data for carrying out the basic features without the operating and/or display module. Preferably, the device module is capable of running a preset operating state without the operation and/or display module, however, it may not set a new operating state using a display unit. Data created by operating the operating unit and/or data for the display module may be transmitted in real time between the operating and/or display module and device module.

According to the invention, the handling of the laboratory device is improved by separating the operating and/or display unit from the device module in whole or in part, and arranging it externally in a separate operating and/or display module. The device module may be operated using less space and be lighter than a conventional laboratory device. In addition, the operating and/or display module may comprise a more easy-to-use operating and/or display unit than a conventional laboratory device. In particular, the operating and/or display unit may comprise a more comprehensive input unit and/or a display in a more advantageous size and/or with a higher resolution than a conventional laboratory device. The appropriate size of the operating and/or display unit provides for simplified and/or enhanced operation and/or for a better and more comprehensive display of information compared to conventional laboratory devices. This refers in particular to data of the laboratory device which otherwise will not be displayed due to a lack of space. The operating and/or display module is used to start and/or control workflows of the laboratory device (i.e., impacted in their workflow) and/or to stop, and/or output operating data (e.g., operating parameters, types of operation, workflows, operation states) and/or performance data (e.g., measurement results, dosing volumes, output) of the device module. The operating and/or display module may be arranged separately from the device module, thereby enhancing the handling of the laboratory device and/or improving the readability of the information displayed. Here, the operating and/or display module communicates with the device module to perform a data exchange required for the operation and/or displaying information. If the communication is performed via NFC, the display/control module may have to be moved towards the device (Distance d<5 cm), thus, a connection may not exist at all time. However, it is sufficient to perform an information exchange between the device module and the operating and/or a display module, if required, to exchange data required for operation and display. For wireless communication, not only radio waves but also optical and/or inductive and/or capacitive means may be used.

According to a variant of the invention, the complete operating unit and the complete display unit are integrated into the operating and/or display module.

According to another variant, only the complete operating unit and according to a further variant only the complete display unit is arranged in the operating and/or display module. According to further variants, the operating unit is mainly and/or the display unit is mainly arranged in the operating and/or display module. Accordingly, the larger number of operating elements is arranged in the operating and/or display module and the minor number of operating elements is arranged in the device module and/or the larger display unit, and/or the display unit with a higher resolution is arranged in the operating and/or display module and the smaller display unit is arranged in the device module. In particular, the device module may be configured to comprise only one or a few operating elements for basic features (e.g., triggering of a workflow and dropping of a disposable item) and/or an additional display for some part of the data and the operating and/or display module comprising more operating elements (e.g., to input dosing parameters, routines or programs) and a display unit for all data to be displayed. If the device module is equipped with only one or a few operating elements, the operative handling thereof will be an enhanced.

According to one embodiment, the device module comprises only a part of the operating and/or display units of the laboratory device that are essential for operation, and the other operating and/or display units essential for operation are arranged at the operating and/or display module. For example, a laboratory device configured as a mechanical pipette with a variable dosing volume comprises only a push-button and an adjusting element (e.g., a dial or button) for the dosing volume, and a display for the set dosing volume as required by the operating and/or display units.

According to one embodiment, the laboratory device comprises operating units to start, control and stop workflows and at least one display unit. In addition, mostly one part of said operating and/or display units is arranged at the device module and at least one part of the operating and/or display units is arranged at the operating and/or display module. Thus, the layout of the device module has fewer operating and/or display units. According to one embodiment, the operating and/or display module comprises additional operating and/or display units which are also comprised in the device module. Thus, optionally predetermined handling operations may be defined at the operating and/or display module or the device module, or display information may be read by the user on the operating and/or display module or the device module. According to a further embodiment, the laboratory device comprises operating units to set and/or program workflows, wherein this operating unit is distributed over the device module and the operating and/or display module according to operating units for starting, controlling and stopping workflows. According to one embodiment, the device module comprises only operating units for starting and/or controlling and/or stopping workflows, and the operating and/or display module comprises the other operating units. According to a further embodiment, the display units are exclusively arranged within the operating and/or display module.

The operating and/or display unit enables cost savings as it may be adapted to be used for a plurality of device modules of the same type and/or for different device modules. Thus, one operating and/or device module may be used for several device modules of the same type or of different types. In addition, by using one predetermined operating and/or display module, the manufacturer achieves higher quantities, thereby enhancing the cost efficiency of production. The display device may, in particular, display operating data and/or performance data of the laboratory device. A plurality of device modules may also be operated in sequence with the same operating and/or display module. However, it is also possible to operate a plurality of device modules simultaneously with the same operating and/or display module. The means for wireless communication may comprise several channels, whereby one channel is assigned to each device module, respectively. In addition, communication may be performed via a single channel, wherein device modules may, for example, be assigned by using device-specific data packets. Furthermore, a device module may cooperate with several computing and/or display modules, for example, to support the device module from multiple locations and/or to display information about the work of the device module at several locations.

According to one embodiment, the device module comprises an electronic control unit to detect operating data and/or to control the unit for the treatment of fluids and solids. For example, the control unit may comprise at least one sender to detect operating data of the device module and an electronic means to convert the sensor signals into a signal appropriate for wireless communication. The electronic control unit for controlling the unit for the treatment of fluids and solids may, in particular, comprise an electronic means for operating an electrical driver motor and/or an electric heating device.

The sensor (a pipette or the like), according to one embodiment, is a sensor to detect the set and/or actually used dosing volume. For example, the sensor is a sensor to detect the turning position of a button for setting the dosing volume or a sensor to detect the position of a stop to limit the stroke of a displacement body of a displacement unit or a sensor to detect the respective position or the actual end position of a manual controlled stroke of a displacement unit (e.g., a piston in a cylinder). Displacement sensors may be used for this purpose. If the display unit displays the actually used dosing volume, it may display the currently used dosing volume and/or the dosing volume displayed at the end position.

According to one embodiment, the sensor is a step counter for counting the dosing volume, a force sensor for measuring the attachment force of a pipette tip, an application sensor for detecting the application of the pipette tip on a basis, an acceleration sensor, a proximity sensor for detecting the usage of the device module or a tilt sensor for detecting the alignment of the device module.

According to a further embodiment, the sensor is a sensor for detecting data of the RFID chip integrated into the device module.

According to a further embodiment, data between the device module and the operating and/or display modules are exchanged according to the NFC (near-field communication) standard. NFC is based on wireless identification via radio waves (RFID). However, unlike RFID technology which only allows the reading device to send radio waves to a passive electronic tag (radio label) for identifying and tracking, NFC enables active communication between the device module and the operating and/or display module or other modules. Depending on the embodiment, NFC technology may be adapted to support either read-only or read-write access to another NFC-compatible device. There are two types or modes of NFC communication between the device module and the operating and/or display module(s): a passive communication mode, wherein the initiating device provides the carrier field (carrier wave) and the target device reacts by modulating the existing field (carrier field). In this mode, the target device is able to acquire its energy from the electromagnetic field provided by the initiating device, and thus, the target device becomes a transponder. This is equivalent to the emulation of a RFID tag. In an active mode, both devices, the initiating and target device, communicate by alternately creating their own fields (waves). A device deactivates the radio frequency field thereof while waiting for data. In this mode, both devices normally have a power supply. NFC is especially useful for the authentication of communication partners (device modules and operating and/or display module(s)), and provides better assurance that only authorised devices are communicating, i.e., exchanging data with each other.

A plurality of sensors of the same type or of different types as described above may be integrated into one device module.

According to one embodiment, the operating and/or display module is configured such that operating parameters and/or operation data of the device module and/or control programs of the device module and/or routines for carrying out workflows of the device module may be entered or retrieved by using the operating elements thereof.

The operating and/or display module according to one embodiment is configured to be used for the remote controlling of device modules. For example, a device module may be remotely started and stopped using the operating and/or display module. Operating data and/or performance data may be displayed on the display unit. In addition, the transmission of measurement results and events from the device module to the operating and/or display module may be controlled and retrieved by remote control means.

According to one embodiment, the operating and/or display module is configured to identify, in the event of communication with one of a plurality of device modules, the respective device module, and to automatically set a device-specific user interface on the operating and/or display unit. Hereto, the means for wireless communication may transmit data of different device modules via different channels or transmit data of different device modules with one device-specific ID, respectively. Alternatively, the operating and/or display module may be configured to enable the setting of a device-specific user interface by using a list provided by the operating and/or display module and/or by entering a device number and/or device name.

If an operating and/or display module comprising one or more device modules is used by a plurality of users, a personalisation feature may be integrated into the operating and/or display module. Therefore, according to one embodiment, the operating and/or display module is configured to enable the use of one or more predetermined device modules only after entering proof of authentication. Access to sensitive samples may hereby be limited to a predetermined group of persons, for example. According to one embodiment, the operating and/or display module is configured to perform proof of authentication by entering a password and/or by performing a fingerprint and/or retina scan or other appropriate methods. According to one embodiment, the operating and/or display module is configured to allow the creation, display and modification of predetermined programs, routines, measurement results and other data only after entering proof of authentication.

In addition, the laboratory device may be integrated in an organizational function. According to one embodiment, the operating and/or a display module is configured to comprise a reservation feature which allows the laboratory device to be locked for predetermined periods of time for predetermined users. By using assigned IDs, these persons and/or group of persons for whom the laboratory device is reserved, according to exactly specified periods, may be identified unambiguously. According to a further embodiment, the operating and/or display module is configured to output information about whether the laboratory device is available for use, whether usage of the laboratory device is completed, whether a desired operating state (e.g., desired temperature) has been achieved or which status a running application has achieved. This feature may be controlled, managed and/or supported by the higher-level information management system.

According to one embodiment, the operating and/or display module comprises switches and/or buttons and/or a keyboard and/or microphone and/or display/projector and/or touchscreen and/or speakers and/or acoustic signaling device. The keyboard enables an especially easy input of data. The microphone enables operation via speech input. Alphanumerical characters, images and/or symbols may be displayed using the display. In particular, the display may be an LCD, LED, TFT, OELD or CRT display. The speakers and/or acoustic signaling device enable an additional acoustic information output (e.g., output of speech and/or signal sounds). The acoustic output of noise, sounds or other frequencies may be used to steer the operator.

For identifying device modules and/or selecting a user interface and/or for remote control and/or for interpreting via the personalisation feature and/or organisational function and/or for outputting of information, the operating and/or display unit may be equipped with a respectively adapted electronic control.

According to a further embodiment, the device module may be a handheld device (i.e., it may be carried by hand by the user, in particular in one hand only and more preferably operated using one hand only) and/or the operating and/or display module may be portable (i.e., it may be carried by the user and positioned at any location) and/or may be a handheld device (i.e., it may be carried in particular using one hand only and more preferably operated using one hand only). The advantages of the invention become, in particular, conceivable for a handheld device module. Compared to conventional laboratory devices, it is easier to handle due to its more compact design and reduced and more evenly distributed weight. A portable operating and/or display module may be arranged by the user in a way that provides the best possible operation, and is arranged in the best possible field of vision of the user when in use. The small weight and size of a handheld operating and/or display module allows the user to carry it when in use. For example, the dimensions of a handheld operating and/or display module are designed in a way that it easily fits into the pocket of a common laboratory coat. It preferably is of a size that allows the user to carry it in one hand while operating it.

The operating and/or display module may be a device especially created for use with the laboratory device according to the invention. According to one embodiment, the operating and/or display module is a mobile telephone and/or personal digital assistant and/or a combination of mobile telephone and personal digital assistant (smartphone). Any future products or commercially available products of prior art may be used. Especially, smartphones using the operating system IOS (Apple Corporation) or Android (Google Inc.), but also using other operating systems may be used. Especially, the iPhone of the Apple Corporation may be used, which may be equipped with a dedicated program which has to be developed for this purpose (“app”). According to the requirements of the users of laboratory devices, so-called tablet PCs may also be used, e.g., the iPad (Apple Corporation), a Playbook (RIM Research in Motion) or Samsung Galaxy Tab including the required apps.

Preferably, the display has a high resolution of about 480×320 pixels with about 150 ppi, more preferably at least 960×640 pixels. A diagonal screen measurement of at least 3.5 inches or 8.89 cm, respectively, is preferred. Displays for displaying black/white images and/or color images may be used. As operating elements, buttons, arrows and other keys corresponding to the keyboards of PDAs, smartphones, and so on may be used. Alternatively, the screen may be a touchscreen, e.g., for the iPhone or other devices, and may have a simulated keyboard, e.g., according to the standards of Apple Developer Kits. This includes multi-touch displays and screens with a fingerprint-resistant, oleophobic coating. Alternatively, other pressure or touch-sensitive input devices may be used as operating elements, including the required text recognition methods. Alternatively, speech input may also be used. If pressure or touch-sensitive input media are used, a touch pad (or gesture pads) may be implemented according to the standards of Apple and/or others.

According to a further embodiment, the operating and/or display module comprises a head-up display (HD) and/or transparent display which may be positioned in front of a workspace. These embodiments enable the best possible arrangement of information in the field of vision of the user. According to another embodiment, they are equipped with keys and/or a keyboard and/or other operating elements/controls.

According to one embodiment, the laboratory device comprises a data processing system that is physically separate from the device module and operating and/or display module, and means for wireless or wired communication between the operating and/or display module and the electronic data processing system. The electronic data processing system comprises a PC and/or network and/or server, for example. Using the data processing system, programs for one or more laboratory devices and/or routines to control workflows of one or more laboratory devices may be developed and/or updated and/or evaluated by using data received from one or more laboratory devices and/or processed and/or compressed and/or stored. The programming of programs and/or routines and/or the analysis and/or processing and/or compression and/or storage of data and/or the centralised update of the device modules and/or operating and/or display modules may be performed using the electronic data processing system in a very easy-to-use way. This feature may be controlled, managed and/or supported by the higher-level information management system, whereby the connected database(s) may be accessed.

According to another embodiment, the means for wireless communications communicate using radio waves and/or optical and/or inductive and/or capacitive means. The communication may comprise any current and future technologies and protocols. Particularly suitable are RF protocols such as, for example, keyboards or pointing devices, Bluetooth, WLAN (wireless local area network), WCUSB (wireless certified USB), Zigbee, and 4G. Typical formats include Bluetooth 2.1 and higher plus EDR wireless technology, Bluetooth 3.0 and higher/Bluetooth Low Energy (BLE) or Wibree, UMTS/HSDPA/HSUPA/GSM/EDGE or Wi-fi 802.11b/g/n. For optical transmission, in particular, transmission using infrared radiation especially according to the Infrared Data Association (IrDA), is considered.

Data transmission via radio frequency is described in WO 2008/131874 A1, DE 19506129 A1, DE 199 24 017 A, US 2004/152479 A, WO 95/34960 A. The techniques described here are included by reference in the present invention. The respective descriptions of the documents mentioned above will be included in this application by reference.

According to one embodiment, the operating and/or device module may be connected to the device module in a detachable way. The laboratory device may be used where the operating and/or display module is separate from the device module. In addition, modules may be used in a state where they are connected with each other, similar to a conventional laboratory device. In a connected state, they may form a handheld and/or stationary laboratory device.

According to another embodiment, the laboratory device comprises an electric charging device to charge an electrical energy storage device of the device modules and/or of the operating and/or display module. The electric energy storage device is preferably an rechargable battery or a battery, e.g., a lithium-ion battery. According to another embodiment, the charging device may be connected to the device module and/or the operating and/or display module by electric contacts. According to a further embodiment, the laboratory device comprises an electric charging device to charge the electric power storage device of an operating and/or display module. This enables the charging of an electric energy storage device of the operating and/or display module using the electric charging device of the device module. According to another embodiment, the operating and/or display module comprises an electric charging device to charge an electric power storage device of a device module. This enables the charging of the electric energy storage device of the device module using the operating and/or display module. The operating and/or display module is preferably equipped with an electric charging device, as an easy way of handling of the operating display module is often not significant as it may often be arranged in a stationary way during use.

According to another embodiment, the device module and the operating and/or display module comprise contacts which may be connected to each other for the communication and/or transmission of electric charge between the device module and the operating and/or display module.

The invention will preferably be used in laboratory devices (particular networked laboratory devices) which use a connection to a higher-level information management system during operation. According to another embodiment, the laboratory device is a pipette, a photometer, a centrifuge, a mixer, a thermo cycler, a real-time cycler, a DNA sequencer, a laboratory machine or a dosing station.

For a laboratory device formed as a pipette, the treatment of the fluid consists of the dosing of fluid. The unit for the treatment of the fluid comprises a fluid displacement unit and a drive unit to drive the displacement unit. For a photometer, the treatment of the fluid consists of the optical determination of the composition of the fluid. The unit for the treatment of fluids comprises an optical system with light source, an electro-optic light receiver and a position to arrange the fluid in the beam path between the light source and light receiver. For example, a fluid receiving cuvette may be placeable in this position. For a centrifuge, the treatment of the fluid consists of separating the materials by means of centrifugal force. The unit for the treatment of fluids comprises a rotor with retainers for the sample containers containing the fluids and a drive motor of the rotor. For a mixer, the treatment of the fluids consists in the mixing of the fluid. The unit for the treatment of fluids comprises a support for the sample containers containing the fluids and a drive to shake the support. In addition, a thermo mixer tempers the fluid using a heating device. For a thermo-cycler, the treatment of the fluid consists in carrying out a polymerase chain reaction (PCR). The unit for the treatment of fluids comprises a heating block with retainers for the sample containers containing the fluid, a respective electric heating device and cooling device and an electric power control for controlling the heating device. For a DNA sequencer, the treatment of fluids comprises in the reproduction, chemical marking and analysis of DNA sequences in fluids. For a laboratory machine, the treatment of fluids comprises the automatic performance of at least one of the previously mentioned treatments of fluids. The unit for the treatment of fluids and solids comprises at least one automatic unit for the treatment of fluids and solids of the kind described above. For a dispenser, the treatment of fluids consists of the automatic dosing of fluids. Other examples in the field of bioprocessing technology concern fermenting, cultivating, etc. The unit for the treatment of fluids and solids is a dispensing device, e.g., an automatic pipette.

If the laboratory device is configured as pipette, the embodiment of the device module has a mechanical drive with an operating unit which is driven by the muscular strength of the user. Hereto, the pipette preferably has a traditional push-button or switch for thumb activation. In addition, the device module is provided with at least one sensor to detect operating data and/or performance data. Using the means for wireless communication, the data detected by the sensor is transmitted to the operating and/display module and displayed by the display unit. Communication using the means for wireless communication is directed from the device module to the operating and/or display module unidirectionally. The user uses the mechanical pipette by taking the displayed information into account. The communication from the operating and/or display unit to the device module is carried out by the user. The device module needs only a small power supply for the sensor, means for converting the sensor signals and the means for wireless communication belonging to the device module. A battery, rechargable battery, or capacitor is sufficient as a power supply.

According to one embodiment, the sensor and/or means for wireless communication of the device module are encapsulated, thus the whole device module is autoclavable. Eventually, the power supply unit will be removed from the device module. According to a further embodiment, the power supply and means for wireless communication, if required, as well as the sensor, if required, are housed in an electronic module detachably connected to the device module, which is detachable from the device module for autoclaving. For example, the electronic module may snap to or clip onto the device module. The electro module and/or device module are therefore equipped with snap-to or clip-on means.

According to one embodiment, the device module comprises a plurality (e.g., 3) of operating elements. According to one embodiment, the device module comprises an operating element for the starting and, if required, controlling of and, if required, stopping of the dosing operations. According to a further embodiment, the device module comprises a further operating element for detaching the pipette tip or syringe from the device module. According to another embodiment, the device module also comprises a further operating element for setting the dosing volume to be dosed.

According to one embodiment, the operating element of the device module is a push-button for moving the displacement body of a displacement unit. In this embodiment, the device module preferably comprises a spring, which returns the displacement body and the push-button back to the original position after an output stroke, whereas the displacement body performs the reception stroke. The push-button may be a driving element for manually driving a mechanical driving unit. In addition, it may be an electric operating element (such as a sensing device) connected to an electromechanical drive unit via an electronic control unit in order to control it. According to one embodiment, to eject the pipette tip or syringe, there is an additional operating element coupled with an ejector to separate a pipette tip or syringe from its seat when the additional operating element is activated. According to one embodiment, the push-button is coupled with the ejector and is also adapted to detach the pipette tip or syringe. The push-button is moved beyond the output stroke so that an ejector coupled with the push-button impacts the pipette tip or syringe to separate it from its seat at the device module. According to a further embodiment, the device module is equipped with a rotary knob or a dial to set the dosing volume. The rotary knob or dial is coupled with a unit for setting the dosing volume of the device module, e.g., an adjustable amplitude for limiting the stroke of the displacement body of the displacement unit or an electronic control unit for starting and/or stopping and/or controlling an electromechanical drive unit. The rotary knob or the dial is an additional operating element, according to one embodiment. According to another embodiment, the push-button is also the dial. This device module uses a single operating element.

According to another embodiment of the laboratory device as a pipette, the device module is the semi- or fully electronic device module. A semi-electronic device module is a device module comprising an electric servo drive for the displacement unit. The actuating force of the user impacting the operating element will be intensified by the electric servo drive to drive the displacement body of the displacement unit. For a fully electronic pipette, the displacement body of the displacement unit is driven by an electric drive motor with an electronic control unit. The semi- and fully electronic device module may also be unidirectionally connected to the operating and/or displacement unit to display the operating data of the device module as detected by the sensor of the device module at the operating and/or display unit. According to one embodiment, the operating and/or display unit comprises operating elements adapted to operate the semi- or fully electronic device modules. The communication may be unidirectional from the operating and/or display module to the device module. However, it may also be bidirectional to transmit operating data from the device module to the operating and/or display module, and in the opposite direction control commands to the device module. Preferably, the device module comprises an operating element for starting and/or stopping and/or controlling dosing operations. More preferably, the device module comprises a further operating element to eject the pipette tip or syringe. A pipette refers, in particular, to the types described in the introduction of the specification.

According to another embodiment of the pipette, the operating and/or display module is arranged at the pipette support. According to a further embodiment, the pipette support comprises an electric charging device to charge the electric energy storage device of the device module of the pipette.

According to a further embodiment, the device module comprises a manually driven, mechanically and/or electromechanically driven drive unit for a displacement unit, and/or an ejector. According to one embodiment, the at least one operating and/or display unit is configured to communicate with the device modules only within a predefined spatial area. The means for wireless communication, for example, therefore have a defined and/or adjustable range and/or comprise a unit adapted to determine whether the device module is arranged within a predetermined range around the operating and/or display module, e.g., due to the strength of the received radio signal. The defined range of the means for wireless communication is preferably about 5 cm, more preferably between 1 and 2 cm.

According to a further embodiment, the defined spatial area is limited by a maximum distance or by one or several rooms or parts of a room of a building. If the defined spatial area is limited to one or more rooms or parts of rooms of a building, an ID is integrated into the device modules located within the defined spatial area, for example. The ID may be integrated via the operating and/or display module in the device module or via the operating unit of the device module thereof. Integrating an ID may be performed wirelessly by a centralised site using a unit that stores IDs assigned to the building plan. By using the location of the device modules, the assigned ID of the respective device module is determined. Location data may be inputted into the respective laboratory device and transmitted to the centralised unit or directly inputted into the centralised unit. Location and identification may be transmitted wirelessly, preferably using radio waves.

The operating and/or display unit determines the identification of the device modules communicating with it and displays device modules located in the defined spatial area. The user selects one or more defined spatial area(s) for which the operating and/or display module displays the display modules. Using the operating and/or display module, one or more device modules within that defined spatial area may be operated and/or monitored. Accordingly, the device modules may be operated and/or monitored by using the operating and/or display module from several defined spatial areas. According to one embodiment, the operating and/or device module simultaneously displays the data of a plurality of device modules, and simultaneously enables the operation and/or monitoring of the plurality of device modules.

The laboratory device system according to the invention comprises a plurality of device modules and at least one operating and display module, where the modules are arranged physically separate from each other in separate housings, and the modules communicate preferably wirelessly, exchanging, in particular, data using near-field communication (NFC). At least one device module may be provided which exchanges data with a plurality of operating and display modules, e.g., by using NFC. In addition, a centralised information management system is provided which is arranged remotely from the laboratory device, e.g., at the headquarters of the company producing, delivering, and/or maintaining the laboratory device, or the company using the laboratory device. Communication or data exchange between the laboratory device and the centralised information management system is performed via at least one communication channel (WLAN, UMTS; secure IP connection, etc.) and enables centralised user support during operation of the laboratory device.

In addition, the invention comprises a method for operating a laboratory device for the treatment of fluids and solids. Advantageous embodiments of the method are described in the dependent claims.

In the following, the invention will be described in detail with reference to the appended figures and examples of embodiment.

In the figures:

FIG. 1 shows a conventional laboratory device with a simplified schematic block diagram;

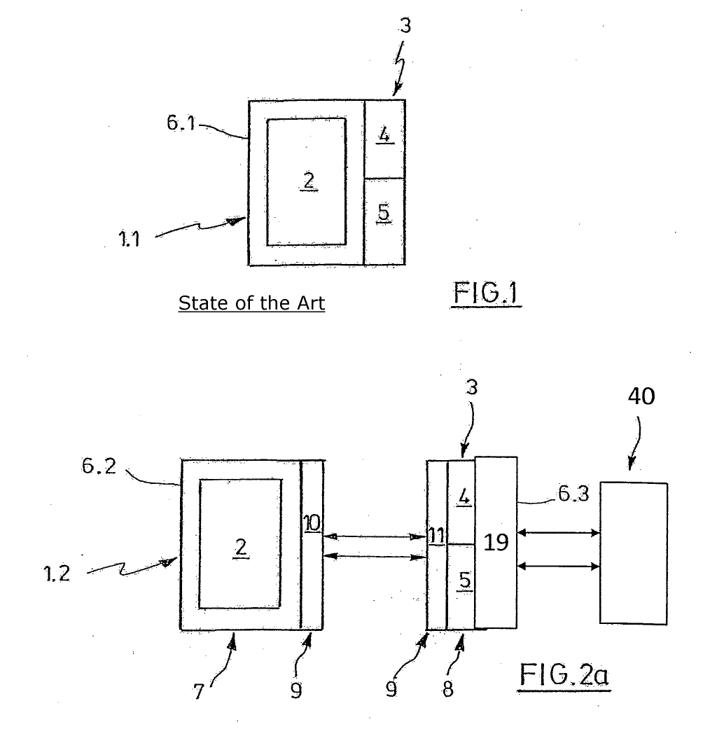

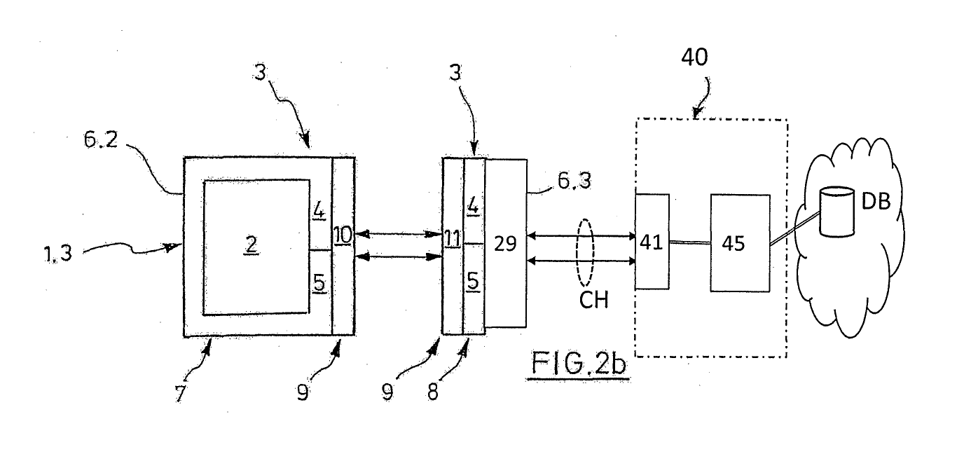

FIGS. 2a and b show variants of laboratory device systems according to the invention in simplified schematic block diagrams;

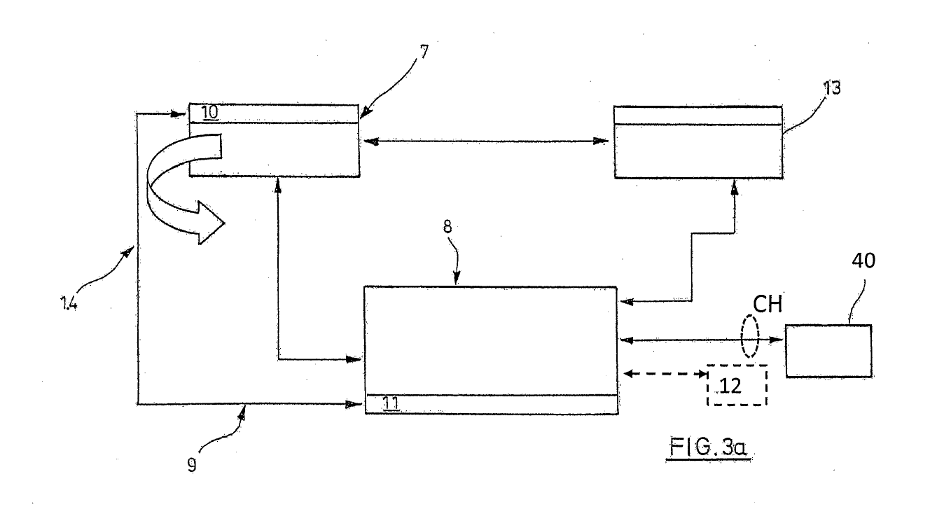

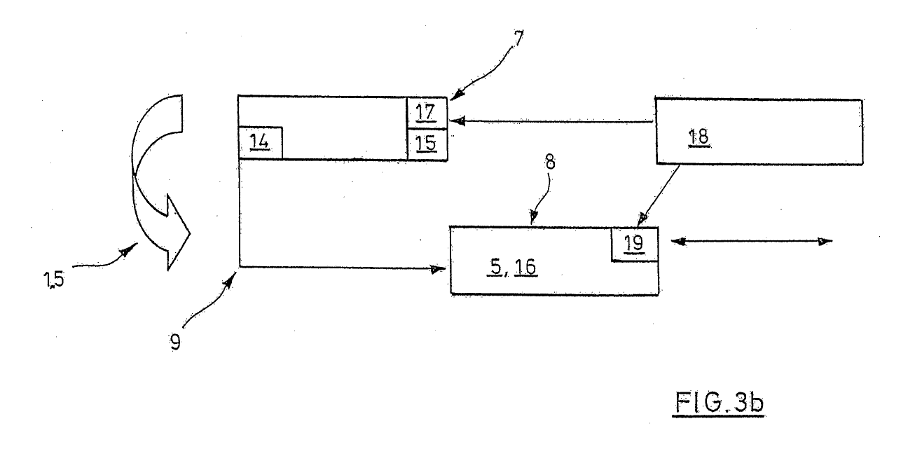

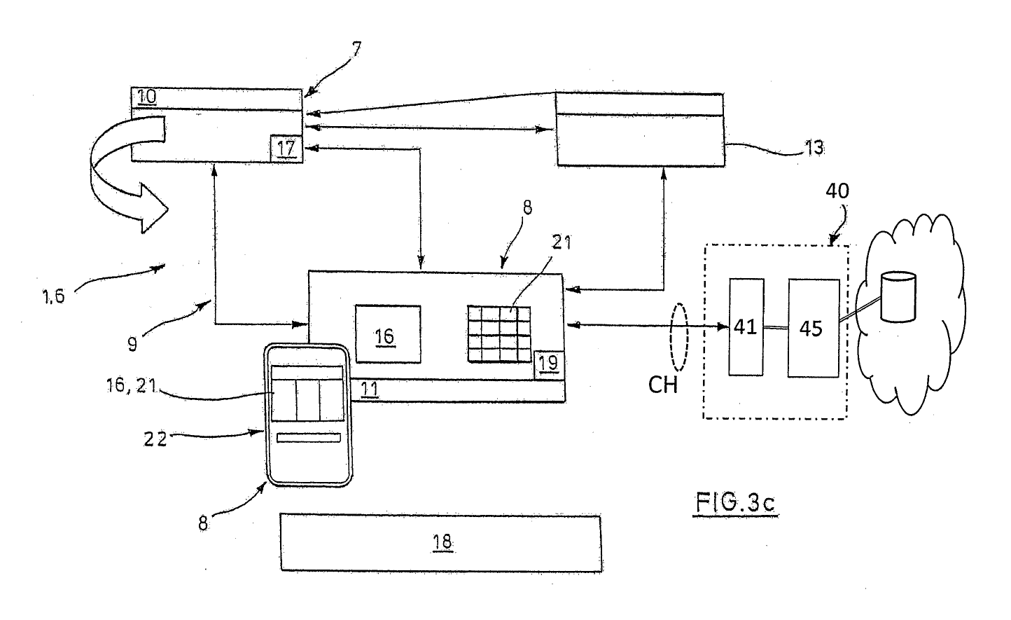

FIG. 3a to c show variants of laboratory device systems according to the invention in block diagrams;

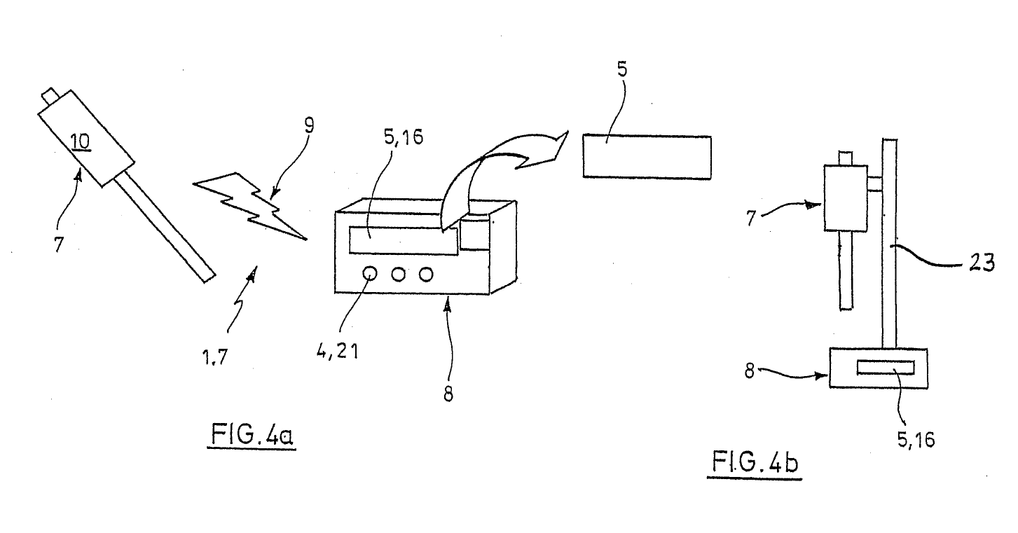

FIGS. 4a and b show a laboratory device according to the invention in the form of a pipette in a schematic perspective view (FIG. 4a) and with existing modules in front view (FIG. 4b); and

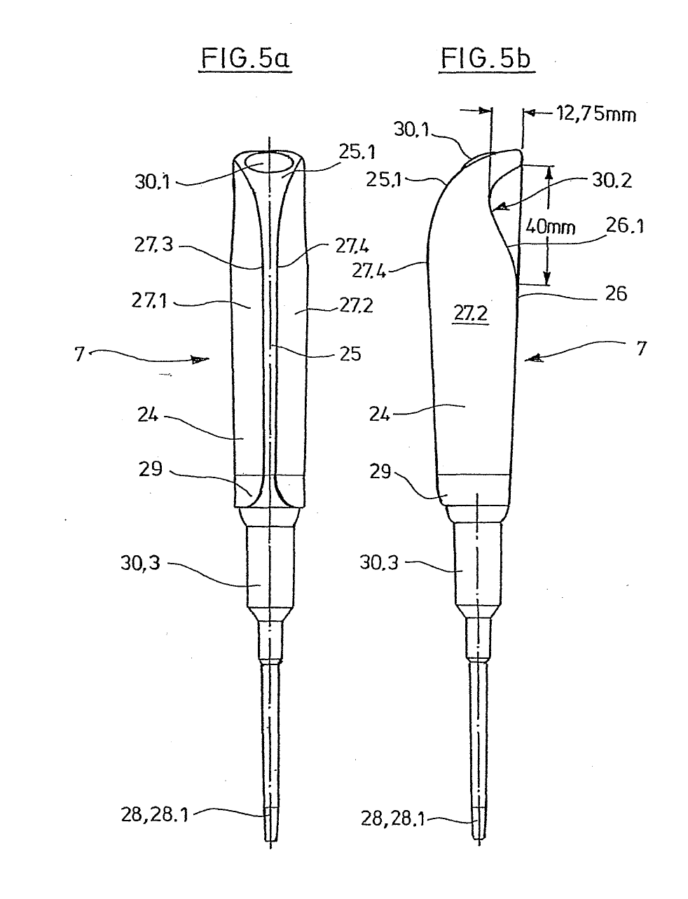

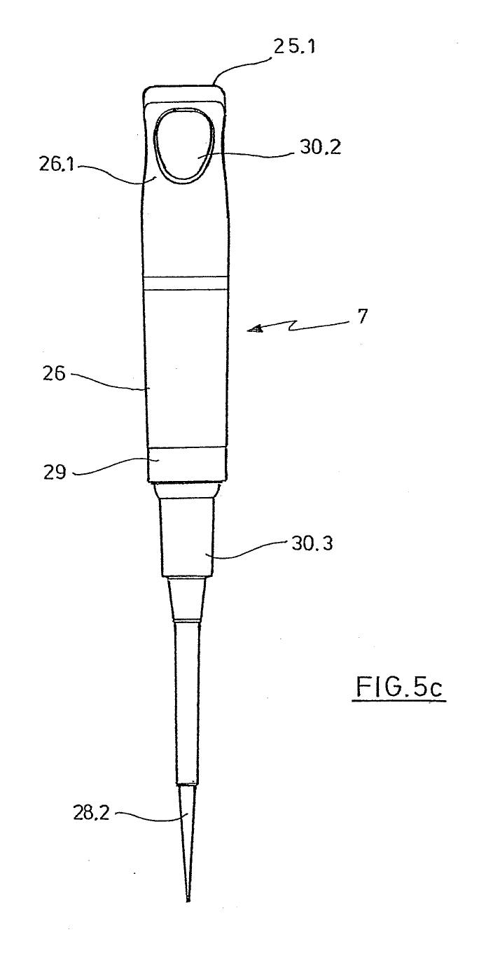

FIG. 5a to c show the device module of a laboratory device according to the invention (here, for example, a pipette) in front view (FIG. 5a) and side view (FIG. 5b), and in rear view with a pipette tip (FIG. 5c).

According to FIG. 1, a conventional laboratory device 1.1 comprises a unit for the treatment of fluids and solids 2 and the operating and/or display unit 3. The operating and/or display unit 3 comprises an operating unit 4 and a display unit 5. The unit for the treatment of fluids and solids 2 and the operating and/or display unit 3 are physically combined in a common housing 6.1. In general, data (measurement data) detected by the laboratory device 1.1 is manually inputted into a computer or PC by the user. Alternatively, laboratory device systems are known where the laboratory device is directly connected to the PC via a data connection (e.g., serial interface RS 232).

In a laboratory device system according to the invention or in a laboratory device designed for this purpose which is schematically shown by example of the device 1.2 in FIG. 2a, the unit for the treatment of fluids and solids 2 is part of a device module 7 with a compact housing 6.2. The operating and/or device unit 3 is physically separated from the device module 7 in a housing 6.3 of an operating and/or display module 8. The operating and/or device module 8 comprises both the operating unit 4 and the display unit 5.

In addition, the device module 7 and the operating and/or display module 8 comprise means for wireless communication 9 which comprise an interface for wireless communication 10 of the device module 7, and an interface for wireless communication 11 of the operating and/or display module 8.

This example shows bidirectional means for wireless communication 9. These transmit data triggered by operating procedures in particular from the operating and/or display module 8 to the device module 7. In addition, they especially transmit operating data that has been detected by the device module 7 from the device module 7 to the operating and/or display module 8.

In addition, the laboratory device system according to the invention comprises an information management system 40 which is located remotely from the laboratory device (e.g., at the headquarters of the device manufacturer and/or the maintenance company), and which exchanges data via one or more communication channels CH with the laboratory device, especially with the operating and/or display module 8. The communication channel CH is established via one or more networks (with their respective gateways), whereby the operating and/or display module comprises means 19 for establishing a wireless communication using a radio network, e.g., a WLAN or UMTS. Thus, the means 19 serves as a (first) gateway. In addition, the information management system 40 also comprises means 41 to establish a communication link, here, a LAN adapter or the like. The information management system 40 also comprises at least one computing unit 45 and at least one database DB (see also FIG. 2b) to manage data for operating one or more laboratory devices.

Based on the device architecture and network structure described herein, a laboratory device system is created which is especially easy to use in terms of the handling of the laboratory device 1.2 and is capable of providing and supporting a plurality of operating and maintenance features in a centralised way. In addition, parts and features of the operating and/or display module 8 may cooperate with the information management system 40 to perform a plurality of new, easy-to-use features. This will be described in detail later.

The laboratory device 1.3 of FIG. 2b differs from the variant of FIG. 2a such that only a part of said operating and/or display unit 3 is arranged externally to the operating and/or display module 8. Only the operating unit 4 or the display unit 5 or parts of the operating and/or display unit 4, 5 or parts of the operating and display unit 4, 5 may be outsourced. Accordingly, the device module 7 comprises the operating or display unit 4, 5 or parts of the operating or display unit 4, 5 or parts of the operating and display unit 4, 5. In particular, it is possible that operating elements and display elements which are especially easy to use or provide easy to read images are arranged externally, whereas operating and display elements for basic features are provided at the device module 7.

The laboratory device 1.4 of FIG. 3a comprises a device module 7, an operating and/or display module 8 which may be directly connected to a PC 12. The operating and/or display module 8 is preferably portable and connected via a wireless communication channel CH to a network that contains the (to be described later) centralised information management system 40. For example, the operating and/or display module 8 is a PDA. A touchscreen is preferably used as an operating and/or display unit 4, 5. Communication between the operating and/or display module is wireless (e.g., via radio). For communication in particular, one or more of the specified technologies—Bluetooth, WC USB, WLAN, ZigBee or IrDA—may be used. An additional router is provided for use of WLAN. WLAN enables communication over a larger distance. A modem 13 may also be used for communication.

The laboratory device 1.4 may be configured to enable wired communication between the modules 7, 8. The device module 7 and the operating and/or display module 8 therefore have electric contacts that may be brought into contact with each other. Hereto, the modules 7, 8 may e.g., be coupled mechanically with each other via clip-in, magnetic adherence or attachment. Electric connection of the modules 7, 8 with each other is also feasible, if required. After establishing an electric contact between the modules 7, 8, the laboratory device 1.4 may be used as a stationary or portable laboratory device.

Communication between the operating and/or display module 8 and the PC 12 is optional and may be performed wirelessly using one of the technologies mentioned above, by wire or by using contacts. Communication between the operating and/or display module 8 and the information management system 40 is carried out via the wireless communication gateway 19 and provides numerous new operating and maintenance features.

For example, the information management system 40 enables especially easy operation for tasks that must otherwise be performed at the operating and/or display module 8. Examples of this are the creation of flow programs for the flow control of device modules 7, the assessment of operating data (especially measurement results) of device module 7, and the structured storage of operating data (especially measurement results).

A laboratory device 1.5 according to FIG. 3b comprises a device module 7 configured as a mechanic pipette with at least one sensor 14 to detect operating data. The device module 7 contains operating elements 15.

In addition, operating and/or display module 8 exists which may be embodied such that it contains only one display unit 5 in the form of a screen 16 and no operating unit.

Operating data are transmitted wirelessly by the means for wireless communication 9, using one of the technologies mentioned above in addition to a wired connection or contacts, from the device module 7 to the operating and/or display module 8. Subsequently, some or all data may be transmitted to the centralised information management system 40, directly or after processing. In addition, the information management system 40 may retrieve data from the laboratory device, in particular from the operating and/or display module 8.

Connecting the laboratory device with the centralised information management system 40 enables, among others, the usage of the operating and/or display module 8 for asset management. if the operating and/or display module 8 is implemented by a mobile communication device (e.g., smartphone, iPad), the geo-location feature of the mobile device may, for example, be used. Given that today's smartphones comprise generally a GPS or another geo-location feature which may be increasingly used within buildings with sufficient local resolution. Thus, the operating and/or display module embodied by a smartphone (or the like) may, in addition to identification, also be used to create an inventory including the geo-space information of laboratory devices. The respective data or information may be forwarded from the smartphone (operating and/or display module 8) offline and/or online to the information management system 40, where it is processed.

For example, in combination with a database/table in the laboratory device, or also in the external control unit or higher-level structure, the current geo-information may be used to adapt the respective laboratory device to local conditions and to configure it. Geo-related device configuration is therefore possible. It may also be used to comply with country-specific legal requirements. For example, the transmitting power and/or frequency of a sender of electromagnetic waves may be adapted according to the current geo-position.

The usage of features of the mobile operating and/or display module 8 (e.g., smartphone, tablet PC, etc.) support and facilitate maintenance tasks. Thus, the module 8 may be used as a maintenance staff module, whereby, for example, through the special authorisation of staff with respect to the laboratory device (e.g., by using NFC) additional information relevant for maintenance may be retrieved and respective maintenance actions may be initiated by the laboratory device (1.2-1.6 8s. FIG. 2a-3c). As NFC is only designed for the transmission of small amounts of data, automatic pairing for, e.g., Bluetooth or Wi-Fi may be executed using NFC after successful authorisation in order to establish a more efficient transmission channel between the device module 7 and the module 8 (i.e., between the actual laboratory device and the smartphone).

In addition, users may be assigned to one or more user groups to provide dedicated support. The user groups (e.g., lab assistants, maintenance staff, device developers) are managed by the higher-level information management system 40, wherein a user forum may also be established and managed as an exchange platform (chat, email, SMS, etc.) by the used laboratory device. Information regarding which user is using which laboratory device is determined as a data pair using NFC. The assignment of these users to a user group in the higher level information management system 40 may be performed using a wireless network connection 19 (Wi-Fi/Bluetooth, etc.) of the laboratory device. However, the information may also be provided via an operating and output device compliant to Wi-Fi/Bluetooth etc. An “expert” may also be conceived as another embodiment, who monitors the forum, answers questions, publishes news about the device and firmware updates, etc. The forum may also use attributes known from CMS or WIKI constructs or social networks (hierarchy levels, sub groups, etc.).

Identification is used to make a very fine-grained decision about who will receive which status messages (alarm, done, etc.) created by the used laboratory device file by SMS, email, etc.

By using NFC identification, unauthorised usage of the laboratory device resulting from a health status of the user may be excluded. For example, the operation of the laboratory device that creates high magnetic fields outside its casing may be deactivated when the user belongs to risk group (persons with pacemakers).

By using NFC identification, the respective entries about the usage of the laboratory device may be generated automatically in electronic laboratory journal.

The user-friendly support of the respective users is of great benefit for many applications: Should the user or the service technician need to remove or exchange one part of the laboratory device, the respective working procedures/service instructions (images, videos, etc.) for exactly this device may be outputted at the (mobile) NFC device after NFC coupling and pairing with the higher-level information management system 40 using an efficient transmission protocol (Bluetooth, Wi-Fi, etc.).

The laboratory device system described herein may, for example, be used for the identification and tracking of consumables (or materials) and “samples”: Because today's smartphones are also equipped-in addition to NFC/RFID transmitters—with digital cameras (barcodes, 2D barcodes, etc.), they may be also used for the automatic identification and tracking of correspondingly (via RFID, 2D barcode, etc.) identifiable consumables/materials that were used by or for the laboratory device. In addition, identifiable samples (via RFID, 2D barcode, etc.) processed by the laboratory device may be detected (liquid handling, analysis, thermo-cycler, mix, etc.). Information obtained in this way may be forwarded offline and/or online from the smartphone or the laboratory device to the information management system, in which they are then processed. In particular, this enables the largely automated tracking of samples beyond the borders of laboratory and devices, which is especially important with respect to ever-increasing regulatory requirements.

Based on the identification of the user in connection with data from the laboratory device, proposals and recommendations for the exchange of spare parts reaching the end of their usage time (“lifetime”) may be generated by the laboratory device (by reading a run time memory). Proposals and recommendations for the purchase of single-use products, for example, may also be generated if they are added to the inventory and management (preventive maintenance).

In this context, an account for the NFC-identified user may be managed in a centralised way, with which the purchase of materials or the purchase of optimized “receipts” or “workflows” (services in general) for its used laboratory device is handled. Referring to FIG. 3B, the construction of the laboratory device 1.5 will be described in detail:

The sensor 14 is, for example, a sensor for detecting a set and/or actual dosing volume, a step counter for counting dosing steps, a force sensor for measuring the application force of the pipette tip, and education sensor for detecting the application of a pipette tip on a surface, an acceleration sensor, a proximity sensor for detecting the usage of the device module 7 or a tilt sensor for detecting the alignment of the device module 7. The tilt sensor is used to enhance the precision of a device module by detecting the slope of the device module.

In addition, the sensor 14 is a sensor for detecting data of the RFID chip integrated into the device module. In principle, the RFID chip data may also be read using a suitable reading device of the operating and/or display module 8 from the device module 7.

The means for wireless communication 9 enables unidirectional communication from the device module 7 to the operating and/or display module 8. This method is cost-efficient, fast and straight forward. The operating data detected by the sensor 14 may be transmitted and displayed in real time and permanently stored in the operating and/or display module 8, if required. The user may be given guidance when using the laboratory device 1.5, wherein additional acoustic signals may be output from the operating and/or display module 8.

Taking a pipette as example, the selection of data provides the following additional benefits:

If displaying a set volume and when modifying the volume, this may be set interactively. The user is able to identify the set volume at any location convenient for performing his work.

The operating and/or display module 8 may be equipped with a calibration feature. This enables the inputting of a physical characteristic (e.g., viscosity) of the fluid to be dosed or the geographic height of the respective location, and displays the assigned calibrated dosing volume for a desired dosing volume. The user may then set these values, interactively, if desired.

Furthermore, the operating and/or display module 8 may determine and display a service interval. The laboratory device may support calls for service, for example, via email or SMS, which may be triggered by the user. In principle, the laboratory device may also call a service automatically.

In addition, the operating and/or display module 8 may be configured to display the perfect fit of the pipette tip and/or output a warning and/or error message in the event that the pipette tip has not been attached with the required attachment force and/or the pipette tip is in contact with a base and/or in the event that the device module is aligned in an unfavorable way.

Required operating data may be forwarded from the operating and/or display module 8 to a downstream application. Forwarding to a PC 12 (see FIG. 3a) may preferably be performed by the information management system 40 via the communication channel CH, or respective networks, servers, etc. Forwarding may be performed wirelessly or by wired connection using one of the technologies mentioned above.

The device module 7 requires a power supply 17 for operating the sensor 14, a unit for converting sensor signals 14 (e.g., A/D converter) and an interface for wireless communication with the operating and/or display module 8. Rechargable batteries may be used for this purpose, for example, lithium-ion batteries. Rechargable batteries may be charged via electric contacts using a charging device 18. This may further charge a power supply 19 of the operating and/or display volume 8.

The transmission protocol of the device module 7 enables the operating and/or display module 8 to identify the device module 7. As a result, a plurality of device modules 7 may cooperate with the operating and/or display module 8 and operating data may be assigned to a plurality of device modules 7. Thus, the operating data of a plurality of device modules 7 may be displayed together and in a unique assignable way.

According to one embodiment, the operating and/or display module 8 contains a mobile telephone with a SIM card (Subscriber Identity Module) to allow data transfer over the mobile network. Accordingly, the device module 7 may comprise a mobile telephone and a SIM card.

According to FIG. 3c, the laboratory device 1.6 comprises a device module 7 with a control unit 20 for controlling the unit for the treatment of fluids and solids. In addition, it comprises an operating and/or display module 8 containing the screen 16 and a basic keyboard with keys 21. The means for wireless communication 9 enables unidirectional or bidirectional communication. The wireless communication techniques mentioned above may be used. In particular, wireless communication may be performed via WLAN and a router or modem 13.

The operating and/or display module 8 may be implemented e.g., using a smartphone 22. A suitable program may be developed and be available on the internet, for example.

The operating and/or display module 8 and the device module 7 are connected using unidirectional or bidirectional means for wireless communication 9. Operating data of the device module 7 may be transmitted to the smartphone 22 using unidirectional means for wireless communication 9 and displayed there, according to the exemplary embodiment of FIG. 3b. By using bidirectional means for wireless communication, the user may also use the operating and/or display module 8 as a programming unit. The data hereto are generated by the device module 7, the operating and/or display unit 8 using external programs and loaded to the device module 7, wherein the program of a computing unit (see 45 in FIG. 3c) of the information management system may run in a centralised way. Thus, the hardware and software of said device module 7 may be reduced significantly. For an electric pipette, for example, the operating and/or display units 8 may be reduced to push-buttons for starting and, if required, stopping dosings, an acoustic signaling unit and an ejection unit for pipette tips or syringes, if required.

According to one embodiment, the charging unit 18 for the power supply of various device modules 7 and/or operating and/or display modules 8 is combined into one single power supply, which may be linked to the modules 7, 8 via electric contacts.

For thermo-cyclers or photo- or spectrometers, the operating and/or display module 8 may transmit the operating and program data to the device module 7 and/or display the operating data of the device module 7 on the display unit 5. Operating data may be stored on the operating and/or display module 8 and transferred to other media, for example, external databases. Using an application for smartphones, e.g., the iPhone, eliminates the high cost factor of conventional laboratory devices.

According to FIG. 4a, a laboratory device (pipette) 1.7 comprises a device module 7 with a displacement unit and a drive unit. In addition, the laboratory device (pipette) comprises an operating and/or display module 8 with an operating unit 4 configured as keys 21 and a display unit 5 configured as a screen 16. Device module 7 and operating and/or display module 8 comprise interfaces 10, 11 for wireless communication.

The display unit 5 is connected to the operating and/or display module 8 in a detachable way. After detaching the operating and/or display module 8, the display unit 5 may be fixed as a mobile clip to a watch, clothing or other objects in the field of view of the user.

FIG. 4a shows the usage of the device module 7 as a portable pipette.

In addition, the device module 7 of the pipette may be connected via a tripod 23 to a stationary pipette using the operating and/or display module 8, as shown in FIG. 4b.

FIGS. 5a to 5c show an exemplary embodiment of a handheld device module 7 of a laboratory device embodied as a pipette according to the invention. The device module 7 comprises a prolonged, largely rod-shaped handle 24.

The handle 24 comprises a front handle surface 25, which bulges in the upper part of the handle 24 above the contact area of the palm of the hand into a thumb rest 25.1. The front handle surface 25 protrudes only in one direction.

The handle 24 comprises a rear handle surface 26 with a recess 26.1 below the upper end thereof. The rear handle surface 26 bulges on both sides of the vertical section in the direction of the lateral handle surfaces 27.1, 27.2, which taper to both sides of the front handle surface 24 with a slowly decreasing curvature, which converge on both sides with a chamfer 27.3, 23.4.

The handles 24 have a height of between 100 to 180 mm and/or a circumference of between 80 to 130 mm. Handle 24 with dimensions within the specified ranges is perceived by users with different hand sizes as comfortable.

A seat 28.1 for a pipette tip 28.2 is arranged on a tubular support 28, which protrudes downwards from the lower end of the handle 24.

Between the seat 28.1 and the handle 24, there is a locking device to fix a joint (not shown) in a predetermined position. The locking device comprises a ring nut 29 to clamp the joint at the lower end of the handle. Using a locking device, the alignment of the seat 28.1 in relation to the handle 24 may be fixed to prevent unintended shifting.

The operating element 30.1, which may be operated using the thumb, is arranged in the thumb element 25.1. The operating element 30.1 is a button-like key. In the cross-section, the key is lenticular and protrudes slightly in an upward direction over the front handle surface 25.

The operating element 30.1 is a start/stop button, which is used to start operating flows or parts of operating flows and stop them, if required. According to one embodiment, the pipette is set in an external operating and display unit (e.g., mode of operation, dosing volume, piston speed) and/or programmed (e.g., several flows of operation in sequence), thus, only the flows may be started or, if required, stopped by using the operating element 30.1. The operating element 30.1 is preferably an electric key.

In the rear handle surface 26, an additional operating element 30.2 is arranged in a recess 26.1. The additional operating element 30.2 is the operating element of a tip ejector 30.3, i.e., a unit for ejecting for detaching a pipette tip or syringe from the pipette.

The additional operating element 30.2 is coupled with a mechanical drive unit—not shown—that is coupled with a tip ejector 30.3, which is assigned the seat 28.1 of a pipette tip or a syringe to detach the pipette tip from the seat when operating the additional operating element.

In the front handle surface 25, a display unit—not shown—may optionally be arranged, e.g., a LCD display. The display unit preferably has an elongated form which extends in the longitudinal direction of the front handle surface 25. The display device is preferably arranged in the lower part of the handle. It is used to display operating data, e.g., a mode of operation or dosing volume, and/or the charging state of the battery or rechargable batteries and/or an error message and/or a warning.

The device module 7 may be embodied in a compact and light way with an advantageous weight distribution. The operating elements 30.1, 30.2 are arranged in an ergonomical way.

As FIG. 5a-c show by example of a pipette, the device module 7 may comprise at least one operating element (15) for controlling the dosing operations and/or detaching the pipette tip (26) or syringe from the device module (7). In addition, the device module (7) may comprise a manual and/or motor drive for a displacement unit and/or an ejector. Furthermore, the device module (7) may comprise at least one drive unit coupled with the displacement body of the displacement unit and/or the ejector and an operating element coupled with the mechanical drive unit for driving the displacement unit using the muscular strength of the user. It may also be provided that the device module (7) does not comprise a display unit. The device module (7) may be shaped in the form of a rod at the upper end. In addition, the operating and/or display module may be arranged at the pipette support.

The laboratory device may be configured such that the device module 7 (see FIG. 3c) comprises an electric charge unit 18 to charge an electrical energy storage device 17, 19 of the operating and/or display module 8 and vice versa, and that electric contacts to transmit electric charge from the device module 7 to the operating and display module 8 or vice versa are provided. The device module 7 and the operating and/or display module 8 comprise contacts which may be connected to each other for the communication and/or transmission of electric charge between the device module 7 and the operating and/or display module 8.

1. A laboratory device system including a least one laboratory device (1.2-1.6) for a treatment of fluids and solids, comprising:
at least one device module (7) with a unit for the treatment of fluids and solids (2), and
at least one operating and/or display unit (3),
at least one operating and/or display unit (8) physically separated from said device module (7), which comprises the operating and/or display unit (3) in whole or in part, and
first means (10, 11) for communicating (9) wirelessly or by wire between the device module (7) and the operating and/or display module (8),
where the laboratory device system comprises an information management system (40) arranged remote to the laboratory device (1.2-1.6) and connected via at least one communication channel (CH), which exchanges data with said operating and/or display module (8) and/or with said device module (7) during operation of the laboratory device (1.2-1.6).

2. The laboratory device system according to claim 1, where said operating and/or display modules (8) of said laboratory device (1.2; 1.3) and/or said device module (7) comprise second means (19) for wireless and/or wired communication between said operating and/or display module (8) or said device module (7) and said information management system (40).

3. The laboratory device system according to claim 1 or 2, wherein said information management system (40) comprises third means (41) for wireless or wired communication with said operating and/or display module (8) or said device module (7) and said information management system (40).

4. The laboratory device system according to claim 3, wherein the third means (41) are adapted to communicate via IP over a network, in particular, an intranet and/or the internet.

5. The laboratory device system according to any one of the preceding claims, wherein the device module (7) is handheld and/or the operating and/or display module (8) is portable and/or handheld by a person.

6. The laboratory device system according to any one of the preceding claims, wherein said operating and/or display module (8) is a mobile phone and/or personal digital assistant and/or smartphone (22) and/or tablet PC.

7. The laboratory device system according to any one of the preceding claims, wherein said operating and/or device module (8) comprises at least one of a camera and/or barcode reader for performing an identification of samples and/or consumables using the information management system (40).

8. The laboratory device system according to any one of the preceding claims, wherein said operating and/or device module (8) comprises at least one locating device, in particular a GPS module, to perform a localization of the laboratory devices, samples, consumables and/or users using the information management system (40).

9. The laboratory device system according to any one of the preceding claims, wherein the information management system (40) and said at least one database (DB) creates and manages a user account for one or more users of said at least one laboratory device, respectively.

10. The laboratory device system according to any one of the preceding claims, wherein the information management system (40) and said at least one database (DB) creates and manages an information forum for at least one group of users and/or laboratory devices, respectively.

11. The laboratory device system according to any one of the preceding claims, where a plurality of device modules (7) and/or a plurality of operating and/or display modules (8) are provided, which communicate with each other via point-to-point connections and/or point-to-multipoint connections.

12. The laboratory device system according to any one of the preceding claims, wherein a plurality of physically separated operating and/or display modules (3) is provided, which communicate with each other via point-to-point connections and/or point-to-multipoint connections.

13. The laboratory device system according to claims 11 and 12, wherein said plurality of device modules (7) and/or said plurality of operating and/or display modules (8) communicate with the plurality of operating and/or display units (3) via point-to-point connections and/or point-to-multipoint connections.

14. The laboratory device system according to any one of the preceding claims, wherein the information management system (40) comprises at least one computing unit (45) which is connected to a database (DB), in particular to a database configured as a Cloud.

15. The laboratory device system according to any one of the preceding claims, wherein first means (10, 11) for wireless communication (9) between the device module (7) and the operating and/or display module (8) are configured such that they communicate only within a defined spatial range, in particular within a near-field range.

16. The laboratory device system according to any one of the preceding claims, wherein second means (19) for wireless or wired communication between said operating and/or display module (8) or said device module (7) and said information management system (40) are adapted to communicate with each other over a defined spatial distance, in particular a distance exceeding the near-field distance or via a remote communication connection.

17. The laboratory device system according to any one of the preceding claims, wherein the device module (7) comprises said electronic control unit for detecting operational data and/or for controlling a unit (2) for the treatment for fluids and solids.

18. The laboratory device system according to any one of the preceding claims, wherein the operating and/or display module (8) is adapted such that operating parameters and/or types of operations of the device module and/or control programs for the device module and/or routines for performing workflows of the device module are input or retrieved using the operating unit thereof.

19. The laboratory device system according to any one of the preceding claims, wherein said operating and/or display module (8) is configured to perform a remote control of the said device modules (7).

20. The laboratory device system according to any one of the preceding claims, wherein the operating and/or display module (8) is adapted to identify in case of communication with one of a plurality of device modules (7) the respective device module (7) and automatically set a device-specific user interface at the operating and/or display unit (8).

21. The laboratory device system according to any one of the preceding claims, wherein said operating and/or display module (8) is configured to allow the usage thereof only after a entering proof of authentication.

22. The laboratory device system according to any one of the preceding claims, wherein said operating and/or display module (8) is adapted to allow the modification of predetermined programs, routines, measurement results and other data only after entering a proof of authentication.

23. The laboratory device system according to any one of the preceding claims, wherein the operating and/or display module (8) is adapted to comprise a reservation feature by which the laboratory device may be blocked for predetermined users for predetermined periods of time.

24. The laboratory device system according to any one of the preceding claims comprising an electronic data processing system (12) that is physically separate from said device module and said operating and/or display module (8), wherein said information management system is implemented.

25. The laboratory device system according to any one of the preceding claims, wherein said operating and/or display module (8) may be coupled detachably to said device module (7).

26. The laboratory device system according to one of the preceding claims, which is a mechanical, electronic or semi-electronic pipette, a photometer, centrifuge, mixer, thermo-cycler, real-time cycler, DNA sequencer, laboratory machine, dosing station, bioreactor or bioreactor system.

27. A method of operating a laboratory device (1.2-1.6) for the treatment of fluids and solids, comprising an unit (2) for the treatment of fluids and solids and at least one operating and/or display unit (3), wherein
at least one device module (7) comprising said unit for the treatment of fluids and solids is operated physically separated from said at least one display module comprising said operating and/or display unit, and
information, control data and/or data to be displayed are transmitted wirelessly between said device module (7) and said operating and/or display module (8); and
data are exchanged via at least one communication channel (CH) with an information management system (40), which is remote to said laboratory device (1.2-1.6).

28. A method according to claim 27, wherein a plurality of device modules exchange data with at least one operating and/or display module, or wherein at least one device module exchanges data with said plurality of operating and/or display modules.

29. A method according to one of claim 27 or 28, wherein said device module is used for pipetting and/or photometrically analysing and/or centrifuging and/or adjusting the temperature and/or mixing and/or cultivating and/or fermenting and/or performing a PCR.

30. A usage of the laboratory device system according to one of claims 1 to 26 to detect and document:
(a) usage data; and/or
(b) data of said treated fluid and/or solids probe; and/or
(c) data about said consumables used; and/or
(d) measurement data, where said laboratory device actively performs measurements; and/or
(e) application data of applications.

31. The usage according to claim 30, wherein the detected and documented data is provided to other users for access.
